(19) United States
(12) Patent Application Publication
(10) Pub. No.: US 2022/0147954 A1
(43) Pub. Date: May 12, 2022

(54) PREDICTION OF BILLING DISPUTES

(71) Applicant: Telefonaktiebolaget LM Ericsson (publ), Stockholm (SE)

(72) Inventors: Saravanan Mohan, Chennai (IN); Kollapalli Ganesh, Irala (IN); Perepu Satheesh Kumar, Chennai (IN)

(21) Appl. No.: 17/434,838

(22) PCT Filed: Feb. 28, 2019
(86) PCT No.: PCT/IN2019/050164

§ 371 Date: Aug. 30, 2021

(51) Int. Cl. G06Q 20/10; G06N 3/04

(52) U.S. Cl. CPC G06Q 20/102; G06N 3/0481; G06N 3/0454

(57) ABSTRACT

The present disclosure relates to methods, as well as corresponding systems, computer programs, computer program products, and computer-readable media. The method comprises training a model to predict, based on data about a collection of uses of a communication service, whether the collection of uses of the communication service is likely to lead to a billing dispute. The training is performed using historical data. The historical data includes data about multiple collections of uses of the communication service and information regarding whether bills generated for the respective collections of uses of the communications service have been disputed by customers. The method comprises obtaining data about a new collection of uses of the communication service by a customer. The method comprises predicting, using the trained model, whether the new collection of uses of the communication service is likely to lead to a billing dispute.

### TECHNICAL FIELD

The present disclosure generally relates to billing disputes, and more specifically to prediction of billing disputes.

### BACKGROUND

Telecom companies face a lot of challenges to generate a profit because of several factors such as competition, dependencies, increasing cost and importantly the continuous change in technological trends. The companies are required to foresee more on business impacts, requirement, future market conditions and financial factors to sustain in the business rather than handling unnecessary disagreements in charging and billing issues. One of them is credit issuing against customer's dispute. While disputes are difficult to avoid completely, it would be desirable to reduce the time and effort that needs to be spent on dealing with disputes.

Disputes can arise in any part of business where there is difference in opinion between the two or more parties regarding documents, invoices, data, etc. In telecom industries most of the billing dispute activities starts from the customer when they receive invoice from the operator. If the customer raises a dispute, operator reaches to clearing house to perform verification on generated invoices from the operator to operator. Billing disputes may be caused by errors in the bills/invoices. There may be many different reasons behind such errors. The telecom business can be broadly classified into major areas such as retail, whole sales (enterprises) and operator to operator for providing the telecom service related to voice\non-voice (data) etc. An example area that may be considered is dispute management related to voice business (national\International). The following are factors highlighting the importance of addressing issues related to disputes.

For some telecom companies, dispute win rate % is 51%, which is approximately resulting to issue the credit value of 1 M USD per annum.

Dispute TAT (Turnaround time) may vary. For some telecom companies, the average time to resolve the dispute is that 60% to 70% of the disputes are getting resolved within 10 days of time, while the remaining 30 to 40% of the disputes are resolved after more than 10 days.

The TAT may have a major impact on customer satisfaction, which may be measured by Customer Satisfaction surveys.

The number of disputes filed by the service provider may for example be 85 per month on an average, and it may increase during different seasons.

Dispute value is directly considered for calculating the billing accuracy and currently it is around 98% for some telecom companies (against average invoice value generated is 80 to 110 M USD per month).

FIG. 1 shows an example of a dispute management procedure in the form of a flow chart. Most of the process here is manual and each operator involves several resources to solve the dispute issues. Some of the operators created their own dispute management center and spend almost 10 million for the operations per year. That is, dispute management incurs significant costs to the operators.

In such an existing dispute management system, it will take time to identify the root causes of disputes. After understanding the root cause of a dispute, taking decisions to solve the problem is often challenging and time consuming. Sometimes, it is very difficult to identify the reason behind the problem because of variance in rating done at the source or tampered call detail records (CDR) generated. If the process to identify the root cause takes too much time, this may cause customers to lose their trust in the service provider, and customers may go for a legal action. If disputes are not solved quickly enough, the service provider may lose confidence with customers. Many customers may potentially leave due to dissatisfaction in solving the dispute on time.

FIG. 2 shows an overview of how a clearing house may be employed for dealing with roaming. When a call/event is placed, the Visited Public Mobile Network (VPMN) queries the Host Public Mobile Network (HPMN) about the services to which the roaming user has subscribed, by querying the Home Location Register (HLR). The Call Detail Records (CDRs) are sent to the billing systems in their respective networks. These systems are in charge of processing CDRs and the generation of invoices to subscribers. The VPMN sends CDR information to the HPMN as a Transfer Account Procedure (TAP) file. Certain companies act as a Data Clearing House (DCH) for these files. A DCH is responsible for the transmission and conversion of the TAP files on behalf of the service provider who has hired it. Once the TAP files are received, the HPMN must settle accounts per costs incurred with the VPMN in accordance with the corresponding roaming agreement tariffs.

A challenge in this setting is roaming frauds. Roaming fraud occurs when a subscriber accesses the resources of the HPMN via the VPNM but the HPMN is unable to charge the subscriber for the services provided, but it is obliged to pay the VPNM for the roaming services. Roaming fraud exploits two characteristics:
Longer detection time: since the fraud occurs when the subscriber is in a network other than that of the HPMN, the time required to detect the fraud is longer due to delays in the exchange of data between VPMN and HPMN.
Longer response time: due to lack of control over the systems in which the fraud has occurred, the time to respond to the fraud is longer than if the fraud had occurred in a system owned by the HPMN.
   Considering the above facts, an example dispute process will be explained below in the context of the example system shown in FIG. 3 and the example architecture shown in FIG. 4. At the national/international roaming network 301:
1. Collect CDR from the network.
2. Rate the CALL/SMS/DATA based on the rates configured and generate the rated CDR.
3. Send the rated CDR to the Clearing House 303.
4. The clearing house 303 will forward to the Home Network 302
   At the home network 302:
5. The home service provider will receive the rated CDRs
6. The billing system will charge the end customer for all the roaming services provided based on their predefined service charges.
7. The billing system will generate the invoices and sent it to the customers.
   For disputes regarding the billing:
8. If the customer finds any deviation/dispute in the charges/usage, he/she will raise a dispute.
9. The corresponding charge/usage details will be shared/sent to the clearing house 303.
10. The clearing house 303 (dispute management system) will cross check with the roaming network/partner about the disputed records/CDRs from both the sides and sort out the issue.

As described above, dealing with billing disputes may take plenty of time and/resources. If disputes are not dealt with appropriately and sufficiently quickly, this may cause customers to lose confidence in the service provider, whereby customers may be lost. Hence, it would be desirable to provide new ways to deal with billing disputes.

### SUMMARY

Embodiments of methods, systems, computer programs, computer program products, and non-transitory computer-readable media are provided herein for addressing one or more of the abovementioned issues.

Hence, a first aspect provides embodiments of a method. The method comprises training a model to predict, based on data about a collection of uses of a communication service, whether the collection of uses of the communication service is likely to lead to a billing dispute. The training is performed using historical data. The historical data includes data about multiple collections of uses of the communication service and information regarding whether bills generated for the respective collections of uses of the communication service have been disputed by customers. The method comprises obtaining data for a new collection of uses of the communication service by a customer. The method comprises predicting, using the trained model, whether the new collection of uses of the communication service is likely to lead to a billing dispute.

According to some embodiments, the communication service may relate to calls, and/or data sessions, and/or messages.

According to some embodiments, training the model may comprise determining values for weights in a first neural network.

According to some embodiments, the values for the weights may be determined subject to a first condition that values for some weights are to exceed a first weight threshold.

According to some embodiments, training the model may further comprise determining the first weight threshold using reinforcement learning.

A second aspect provides embodiments of a system. The system is configured to train a model to predict, based on data about a collection of uses of a communication service, whether the collection of uses of the communication service is likely to lead to a billing dispute. The training is performed using historical data. The historical data includes data about multiple collections of uses of the communication service and information regarding whether bills generated for the respective collections of uses of the communications service have been disputed by customers. The system is configured to obtain data about a new collection of uses of the communication service by a customer. The system is configured to predict, using the trained model, whether the new collection of uses of the communication service is likely to lead to a billing dispute.

The system may for example be configured to perform the method as defined in any of the embodiments of the first aspect disclosed herein (in other words, in the claims, the summary, the detailed description or the drawings).

The system may for example comprise processing circuitry and a memory. The memory may for example contain instructions executable by the processing circuitry whereby the system is operable to perform the method as defined in any of the embodiments of the first aspect disclosed herein.

A third aspect provides embodiments of a computer program comprising instructions which, when executed by a computer, cause the computer to perform the method of any of the embodiments of the first aspect disclosed herein.

A fourth aspect provides embodiments of a computer program product comprising a non-transitory computer-readable medium storing instructions which, when executed by a computer, cause the computer to perform the method of any of the embodiments of the first aspect disclosed herein.

A fifth aspect provides embodiments of a non-transitory computer-readable medium storing instructions which, when executed by a computer, cause the computer to perform the method of any of the embodiments of the first aspect disclosed herein.

The effects and/or advantages presented in the present disclosure for embodiments of the method according to the first aspect may also apply to corresponding embodiments of the system according to the second aspect, the computer program according to the third aspect, the computer program product according to the fourth aspect, and the non-transitory computer-readable medium according to the fifth aspect.

It is noted that embodiments of the present disclosure relate to all possible combinations of features recited in the claims.

### BRIEF DESCRIPTION OF THE DRAWINGS

In what follows, example embodiments will be described in greater detail with reference to the accompanying drawings, on which:

FIG. 1 is a flow chart of an example dispute management procedure;

FIG. 2 shows an overview of how a clearing house may be employed for dealing with roaming;

FIG. 3 shows an example system for use of a clearing house;

FIG. 4 shows example architecture for use of a clearing house;

FIG. 5 is a flow chart of a method, according to an embodiment;

FIG. 6 shows a scheme for how dispute prediction in the method in FIG. 5 may be employed to select between different actions, according to an embodiment;

FIG. 7 shows an example of how the architecture in FIG. 4 may be modified to incorporate an example implementation of the method from FIG. 5;

FIG. 8 shows a scheme for how training of a model may be performed in the method in FIG. 5, according to an embodiment;

FIG. 9 shows an example neural network which may be employed in the training in FIG. 8;

FIG. 10 shows a scheme for how data may be entered into a neural network during training of a model, according to an embodiment;

FIG. 11 shows a scheme for how training of a model may be performed with two neural networks in the method in FIG. 5, according to an embodiment;

FIG. 12 shows a scheme for how data may be entered into a neural network after training of a model in accordance with FIG. 10, according to an embodiment;

FIG. 13 shows a scheme for how data may be split in the method in FIG. 5, according to an embodiment;

FIG. 14 shows a system, according to an embodiment; and

FIG. 15 illustrates a quality assurance process, according to an embodiment.

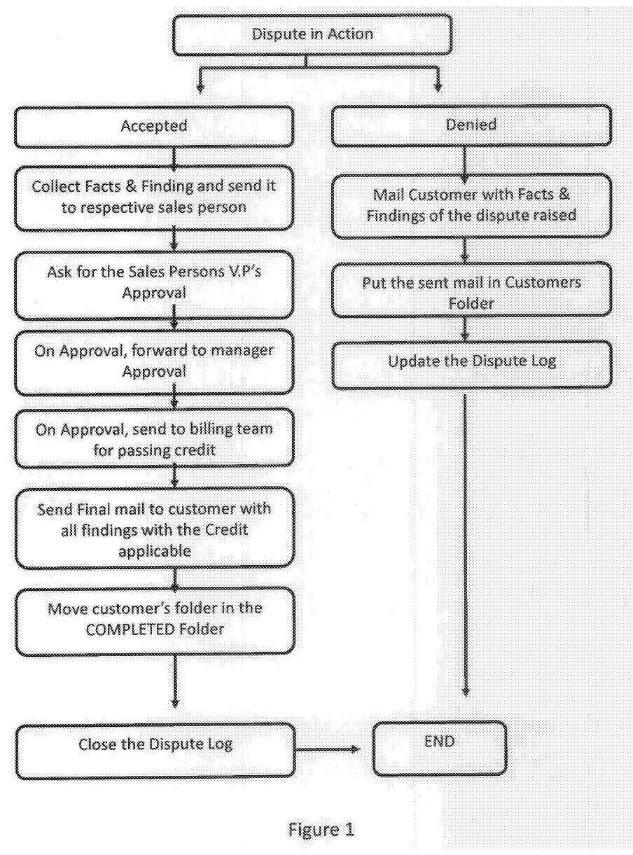

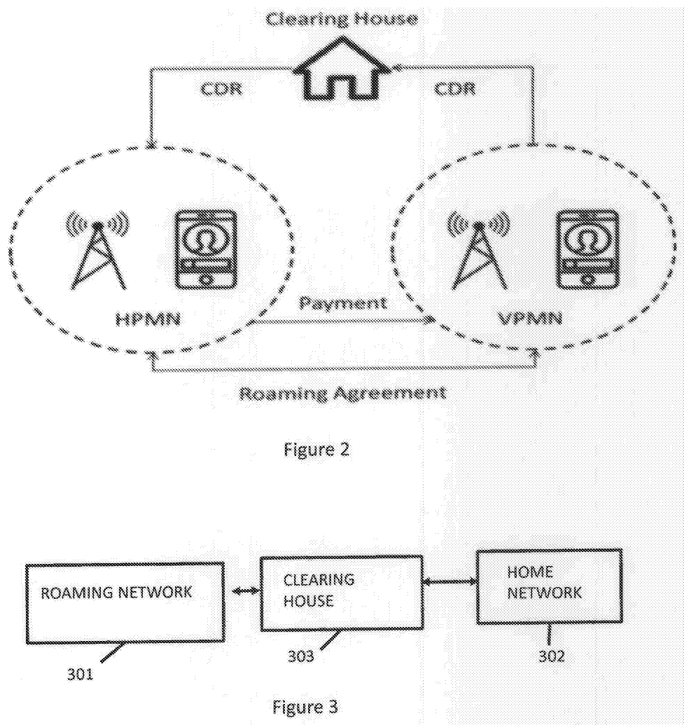

All the figures are schematic, not necessarily to scale, and generally only show parts which are necessary in order to elucidate the respective embodiments, whereas other parts may be omitted or merely suggested. Any reference number appearing in multiple drawings refers to the same object or feature throughout the drawings, unless otherwise indicated.

### DETAILED DESCRIPTION

### 1. General Embodiments of a Proposed Method

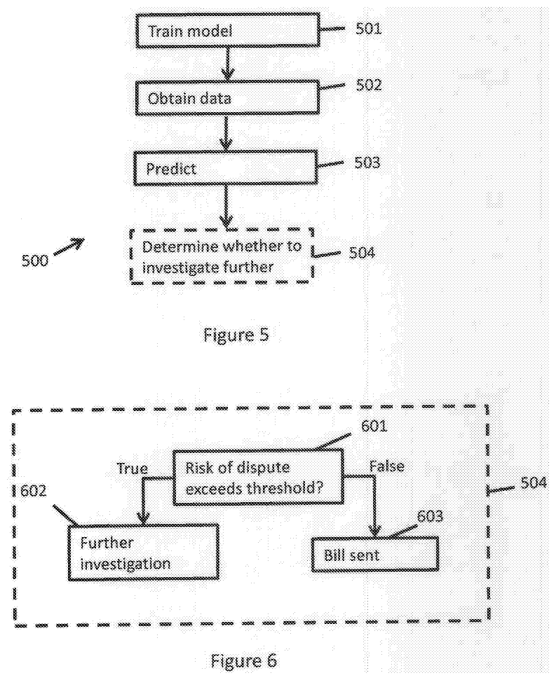

FIG. 5 is a flow chart of a method 500, according to an embodiment. The method 500 comprises training 501 a model to predict, based on data about a collection of uses of a communication service, whether the collection of uses of the communication service is likely to lead to a billing dispute. In other words, after the model has been trained 501, it is able to use data about a collection of uses of the communication service to predict whether the collection of uses of the communication service is likely to lead to a billing dispute (that is, that a bill or invoice sent to a customer for the collection of uses will be disputed by the customer). The training 501 is performed using historical data. The historical data includes data about multiple collections of uses of the communication service and information regarding whether bills (or invoices) generated for the respective collections of uses of the communication service have been disputed by customers. The historical data may be obtained in any way. The historical data may for example be received, or may be retrieved from a memory or database. The customers may for example be individual persons, or a company paying bills for multiple employees.

The method 500 comprises obtaining 502 data about a new collection of uses of the communication service by a customer. In other words, the obtained 502 data relates to uses of the communication service made by the customer. The data about the new collection of uses of the communication service by the customer may for example be obtained 502 after the historical data, for example after training 501 of the model. The data about the new collection of uses of the communication service by the customer may for example be received, or may be retrieved from a memory or database.

The method 500 comprises predicting 503, using the trained model, whether the new collection of uses of the communication service is likely to lead to a billing dispute. In other words, the trained model is employed to predict 503 whether a bill (or invoice) generated for the new collection of uses of the communication service is likely to be disputed by the customer (that is, it predicts whether a billing dispute is probable).

As described above in the background section, billing disputes may take plenty of time and/or resources to deal with, and may cause customers to lose confidence in the service provider. By predicting whether a new collection of uses of the communication service is likely to lead to a billing dispute, such a billing dispute may be prevented. Telecom service providers may for example save significant costs if a portion of the total amount of billing disputes may be prevented.

A collection of uses of the communication service referred to in the method 500 may for example be those uses of the communication service made during a certain time period (such as during a month) and for which a bill is normally sent to customers.

The method 500 may for example be a computer-implemented method.

The method 500 may for example be performed in a billing system.

The model employed in the method 500 may for example be a machine learning model, such as an artificial neural network.

The communication service referred to in the method 500 may for example be a telecommunication service, such as a wireless communication service.

According to some embodiments, the communication service referred to in the method 500 relates to calls, such as voice calls and/or video calls. In other words, the uses of the communication service referred to in the method 500 may be calls of the customer. The calls may for example be made by the customer or may be received by the customer.

According to some embodiments, the communication service referred to in the method 500 relates to data sessions. In other words, the uses of the communication service referred to in the method 500 may be data sessions employed by the customer.

According to some embodiments, the communication service referred to in the method 500 relates to messages, such as text messages. In other words, the uses of the communication service referred to in the method 500 may be messages of the customer. The messages may for example be sent by the customer or may be received by the customer.

According to some embodiments, the method 500 comprises determining 504, based on the prediction 503, whether the data (obtained at step 502) for the new collection of uses of the communication service is to be investigated further before a bill is sent to the customer for the new collection of uses of the communication service. Further investigation may for example reveal that there is a problem with the bill for the new collection of uses of the communication service, and that an error should be corrected before the bill is sent to the customer. The further investigation may for example detect a problem even before the bill is generated. In some cases, the further investigation may not reveal any problems with the bill for the new collection of uses of the communication service. In that case, the bill may for example be sent to the customer. The further investigation may for example be performed manually by a human, but could for example be performed at least partly by a computer program.

FIG. 6 shows a scheme for how the dispute prediction 503 in the method 500 may be employed to select between different actions, according to an embodiment. In the present embodiment, a threshold is employed to determine which action to take. More specifically, it is checked 601 whether or not the predicted 503 risk of a billing dispute exceeds a threshold.

In the embodiment depicted in FIG. 6, the method 500 comprises, in response to the prediction 503 indicating that a risk for a billing dispute for the new collection of uses of the communication service exceeds a threshold, providing 602 signaling for causing at least some (or all) of the data (obtained at step 502) about the new collection of uses of the communication service to be sent for further investigation. In other words, further investigation is performed if the risk of a billing dispute is too high (which is checked 601 using a threshold). The further investigation may for example be employed to determine whether there is actually something incorrect or suspicious with that data. If the further investigation does not reveal any problems with the bill, then the bill may for example be sent to the customer without modifications. The actual step of sending at least some of the data about the new collection of uses of the communication service for further investigation, and/or the actual step of performing the further investigation of at least some of the data about the new collection of uses of the communication service may for example be comprised in the method 500.

In the embodiment depicted in FIG. 6, the method 500 comprises, in response to the prediction 503 indicating that a risk for a billing dispute for the new collection of uses of the communication service is below a threshold, providing 603 signaling for causing a bill to be sent to the customer based on the data (obtained at step 502) about the new collection of uses of the communication service. The bill may for example be generated based on the data about the new collection of uses of the communication service, and may then sent to the customer. The actual step of sending the bill to the customer may for example be comprised in the method 500.

The steps 601, 602 and 603 may for example be regarded as comprised in the step 504.

In some cases, the risk predicted at step 503 may turn out to be equal to the threshold employed at step 601. It will be appreciated that since this situation is rather uncommon, it does not matter that much whether the step 602 or the step 603 is performed in this situation.

### 2. Example Implementation of the Proposed Method

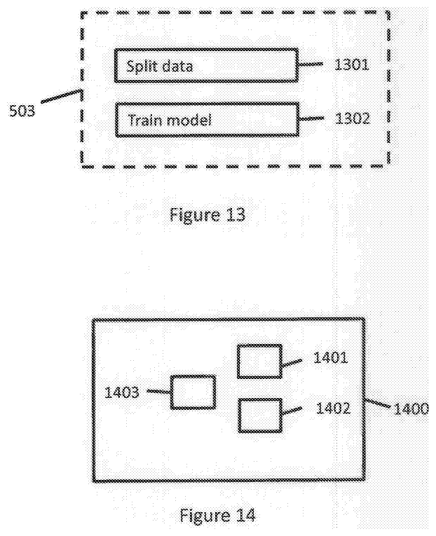

The telecom industry is a wide/complex business in the market in which it is very difficult to cover all types of intricacies in telecom products and relevant dispute management. Hence, to understand the root causes of problems would be a preferred solution for future sustainable business. The business can be classified as voice, non-voice (data, cloud computing, end to end services), etc. Several of the examples presented in the present disclosure are directed to voice-related business and its customer queries for those services interchanging between the operators. Since a voice call may begin and end at more or less any time, such services may be regarded as being provided in a continuous space. As described below, for example with reference to FIG. 13, such continuous variables can be discretized, as part of a solution for the dispute prediction problem. As will be further described below, dispute patterns may be identified to address issues in advance, rather than only dealing with disputes after they have been initiated by customers.

A solution may be provided based on designing a new sequence-to-sequence model for structured prediction of patterns in call detail records (CDRs) behind the disputes to develop policies over discretized spaces which may predict possibly matching dispute patterns in advance.

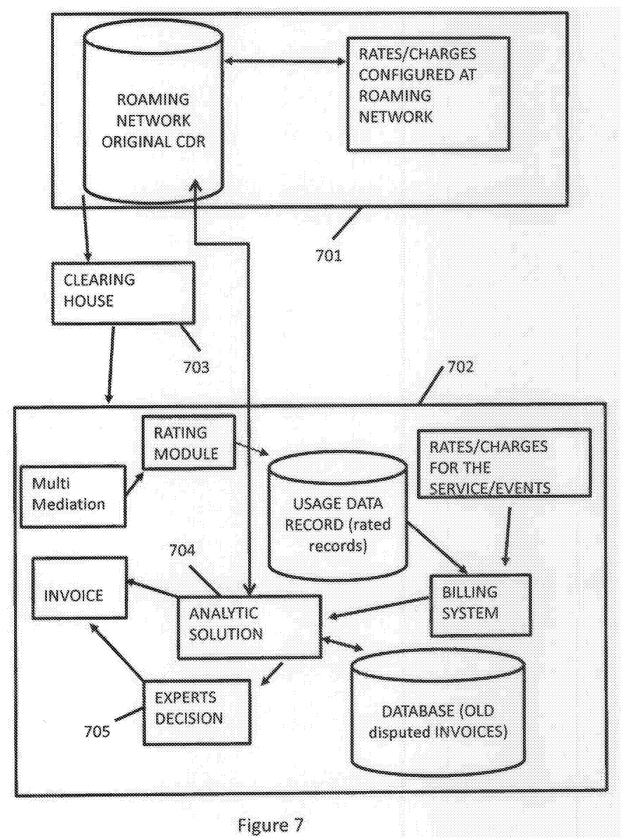

The processing of checking the quality of the CDR's in AI-based analytic module (see the below description of FIG. 7) and segregating them into probable disputed CDR's and correct CDR's with specific reasons can be determined as a Quality Assurance Process. Also a QA Team can take a decision based on the configurable amount to make changes or indicate the CDR's to send for more clarification with clearing house. In general, Quality assurance (QA) is any systematic process of determining whether a product or service meets specified requirements. We propose building a quality assurance system which may increase customer confidence and an operators' credibility, while also improving work processes and efficiency, and that enables a service provider to better compete with others.

This way of predicting the disputes and addressing the issues in advance may be included in charging and billing solutions for providing cost benefit to service providers.

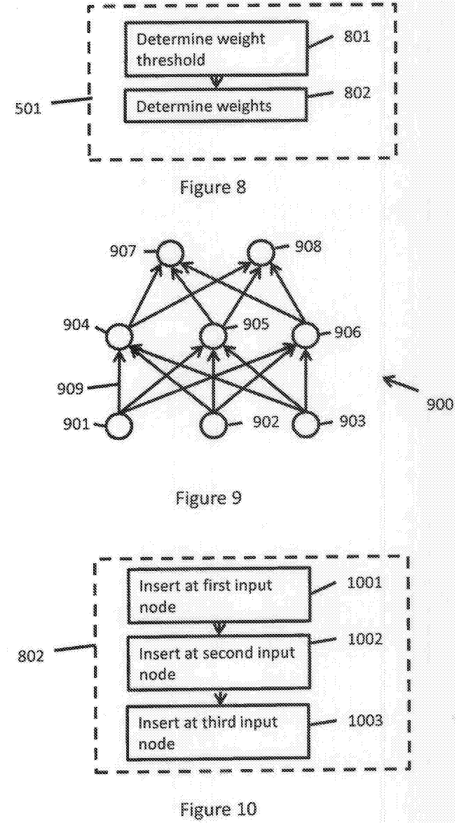

The inventors have realized that complex continuous functions related to the reasons of dispute patterns in high dimensional spaces can be modeled by neural networks that predict and connect the specific discrete dimensions for each issue. An example of such a neural network is described below with reference to FIG. 9. As described below with reference to FIG. 8, reinforcement learning such as Q-learning may be employed in combination with a neural network. With the application of Q-learning values, the neural network predicts dispute sequences in the given data.

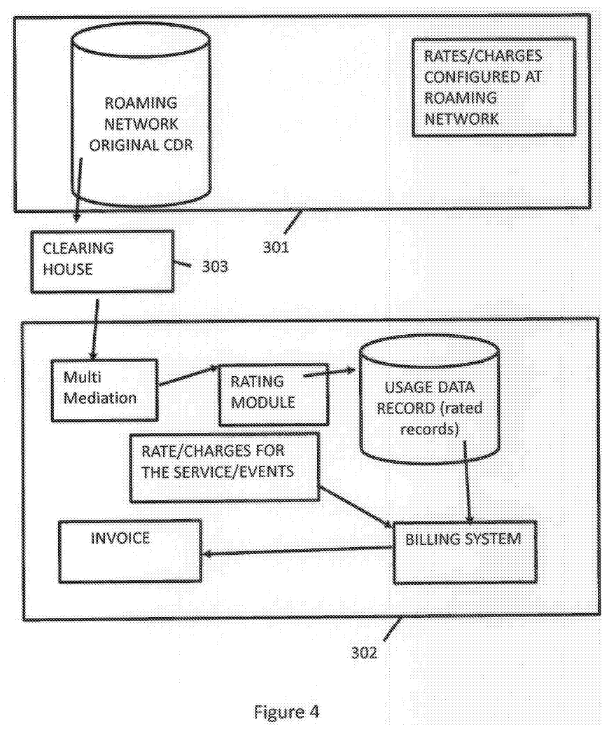

FIG. 7 shows an example of how such an AI-based solution (referred to as analytic solution, 704, in FIG. 7) can be included in the architecture from FIG. 4 for tracing future dispute issues in advance. This is an example implementation of the method 500.

At a the national/international roaming network 701, the same procedure is followed as for the system described above with reference to FIG. 4.

At the home network 702:
1. The home service provider will receive the rated CDRs.
2. The billing system will charge the end customer for all the roaming services provided based on their predefined service charges.
3. The billing system will generate the invoices
4. Invoices will be given to the AI-based ANALYTIC SOLUTION 704
5. ANALYSTIC SOLUTION 704 will cross check with the old history of the customer along with the disputes history for the country's roaming partners.
6. If it finds any suspicious calls indicating that there will be disputes, then further investigation of the invoices is performed, for example manually by humans (indicated as EXPERTS DECISION, 705, in FIG. 7). Otherwise the invoices are sent to customers.
7. If EXPERTS 705 find any deviations, then the invoices will be crosschecked with the clearing house 703.
   For disputes regarding the billing:
8. Will cross check with customer/partner about the disputes.
9. If it's a dispute then, it follows the legacy way of settling it. In this process, the disputed details will be handed over to the clearing house 703.
10. The clearing house 703 takes the full responsibility to solve and settle the disputes.

By introducing the ANALYTIC SOLUTION component in the charging and billing module, dispute patterns may be predicted, and the system can act as an expert system for dispute management.

### 3. Neural Network

According to some embodiments, the step 501 of training the model comprises determining values for weights in a neural network. In other words, the model may include an artificial neural network, and at least some of the historical data may be employed for determining or computing suitable values for weights in this neural network. An objective function, such as a cost function or loss function may for example be employed for evaluating performance of the neural network, so that suitable values for the weights may be determined. An iterative approach, such as gradient descent, may for example be employed for determining values for the weights.

FIG. 9 shows an example artificial neural network 900 which may be employed in the training 501. The neural network 900 comprises tree input nodes 901-903, a layer of hidden nodes 904-906 and two output nodes 907-908. Real or complex numbers are inserted as input at the input nodes 901-903, and output is provided by the output nodes 907-908. The neural network 900 includes paths 909 between the nodes 901-908. At the hidden layer, each node 904-906 forms a weighted sum of the values from the input nodes 901-903. Each of the output nodes forms a weighted sum of the values from the nodes 904-906 in the hidden layer. An activation function may be employed at the nodes 904-906 of the hidden layer and/or the nodes 907-908 of the output layer. An example activation function is the Sigmoid function, which may be employed in the neural network 900. The neural network 900 may for example be a multilayer perceptron.

Example implementations of embodiments will be described with reference to FIG. 9. However, it will be appreciated that other neural networks may also be employed. For example, the neural network 900 may have more than three input nodes, and/or more than one hidden layer. However, the computational complexity of the training 501 of the neural network 900 increases as the number of nodes increases. A neural network 900 employed for predicting whether or not there will be a billing dispute could have a single output node instead of two output nodes 907-908. Indeed, if the neural network 900 has two output nodes, one output node 907 may be employed to indicate the probability that there will be a billing dispute, and the other output node 908 may be employed to indicate the probability that there will not be a billing dispute, but it would of course be possible to deduce the same information from a single output node.

According to some embodiments, the values for the weights in the neural network 900 are determined subject to a condition that values for some weights are to exceed a weight threshold. In other words, certain weights in the neural network 900 are not allowed to have values below the weight threshold. For example, the condition may prescribe that values for weights associated with a first input node 901 of the neural network 900 are to exceed the weight threshold. The weight threshold may for example be employed for the weights of all paths 909 leading from the input node 901 to the next layer of nodes 904-906. This assures that data provided as input at the first input node 901 is given at least a certain weight in the neural network 900. This may be useful if for example data inserted at the first input node 901 is believed to be more important than data inserted at the other input nodes 902-903.

The weights in the neural network 900 may for example have values between 0 and 1. The weight threshold may for example be a real number between 0 and 1.

FIG. 8 illustrates such an embodiment, where the step 501 of training the model comprises determining 801 a weight threshold, and then determining 802 values for weights in a neural network 900 subject to a condition that values for some weights are to exceed the weight threshold. As will be described further below, the weight threshold may for example be determined using reinforcement learning.

FIG. 10 shows a scheme for how data may be entered into a neural network 900 during training 501, according to an embodiment. This embodiment will be described with reference to the neural network 900 in FIG. 9. In the present embodiment, the historical data employed at step 501 includes data about multiple collections of uses of the communication service by the customer and information regarding whether bills generated for the respective collections of uses of the communication service by the customer have been disputed. In the present embodiment, the step 501 of training the model (or rather the step 802 of determining values for weights in the neural network 900) comprises
inserting 1001, at the first input node 901, data from the historical data regarding uses of the communication service by the customer,
inserting 1002, at the second input node 902, data from the historical data regarding uses of the communication service by the customer when visiting a certain country, wherein the data inserted at the second input node 902 relates to uses of the communication service for which bills were disputed, and
inserting 1003, at the third input node 903, data regarding uses of the communication service by customers when visiting the certain country, wherein the data inserted at the third input node 903 relates to uses of the communication service for which bills were disputed.

In the present embodiment, the data inserted at the first input node 901 is data about the one or more most recent collections of uses of the communication service by the customer for which there is data included in the historical data. In other words, the historical data includes additional collections of uses of the communication service by the customer, but these additional collections of uses occurred earlier than those employed for the first input node 901. The data entered at the first input node 901 is intended to reflect the recent behavior of the customer. The data entered at the first input node 901 may for example be data about uses of the communication service by the customer during the last month, or during the last couple of months, while the historical data may include also much older data.

In summary, in the present embodiment, three categories of data are inserted into the input nodes 901-903 of the network 900. Data about recent uses by the customer is inserted at the first node 901 (this data may include uses for which there was a billing dispute and uses for which there was no billing dispute), data about uses by the customer when vising the specific country and for which there was a billing dispute is inserted at the second input node 902 (this data includes both old and recent uses), and data about uses by any customer when visiting the specific country and for which there was a dispute is inserted into the third input node 903 (this data includes both old and recent uses). Some uses of the communication service may be present in several of these categories (such as a recent use by the customer when visiting the specific country, and which led to a dispute), while other uses may be present only in one of the categories (such as an old use by a different customer when visiting the specific country, and which led to a dispute). The data is padded with zeros or other neutral values so that triples of numbers are obtained for insertion into the three input nodes 901-903. Typically, the numbers inserted into the nodes 901-903 are real numbers, but the network 900 could also be configured to handle complex numbers.

The numbers inserted at the input nodes 901-903 all represent the same type of data about the respective uses of the communication service. The type of data may for example be
durations of uses of the communication service; or
start times of uses of the communication service; or
end times of uses of the communication service; or
recipient locations of uses of the communication service.

For the remainder of this example embodiment, we assume for simplicity that the communication service relates to voice calls, and that the type of data entered into the network 900 is the duration of the respective calls. Hence, triples of call durations are inserted into the input nodes 901-903. The output obtained from the network 900 at the output nodes 907 and 908 for this input is compared to the knowledge about whether or not the calls actually led to disputed bills. The network 900 may for example provide predicted probabilities indicating the likelihood of a dispute. Such probabilities may be compared to 1 or 0 depending on whether there actually was a dispute or not. An objective function (such as the sum of squares of the differences between true values and predicted values) is employed to evaluate performance of the network, so that suitable values for the weights in the network 900 may be determined.

FIG. 12 shows a scheme for how data may be entered into the neural network 900 after training, according to an embodiment. In the present embodiment, the step 503 of predicting whether the new collection of uses of the communication service is likely to lead to a billing dispute comprises inserting 1201, at the first input node 901, data from the obtained 502 data about a new collection of uses of the communication service by the customer. In the case where the data relates to call durations, as exemplified above in relation to FIG. 10, durations for new calls of the customer are inserted 1201 at the first input node 901 (the data inserted at the other input nodes 902 and 903 may for example be padding with zeros or other neutral numbers), and the neural network 900 outputs predicted probabilities indicating a risk (or likelihood) that the new calls will lead to a billing dispute.

Since the model has been trained 501 for detecting billing disputes when customers visit a particular country, the data inserted 1201 into the first input node 901 may for example be data about uses of the communication service by the customer when visiting that country. In other words, the model has been trained 501 for predicting roaming-related billing disputes for roaming to a specific country. A similar model may be trained and employed for predicting roaming-related billing disputes for roaming to another country. Another option is to train 501 the model for roaming to any country from a collection of countries (for example all countries except a home country of billing plan applied for the customer). In other words, the data inserted at the input nodes 902-903 in the steps 1002-1003 may relate to uses of the communication service by customers when visiting any of those countries, and the data inserted at the input node 901 in step 1201 may relate to uses of the communication service by the specific customer when visiting any of those countries.

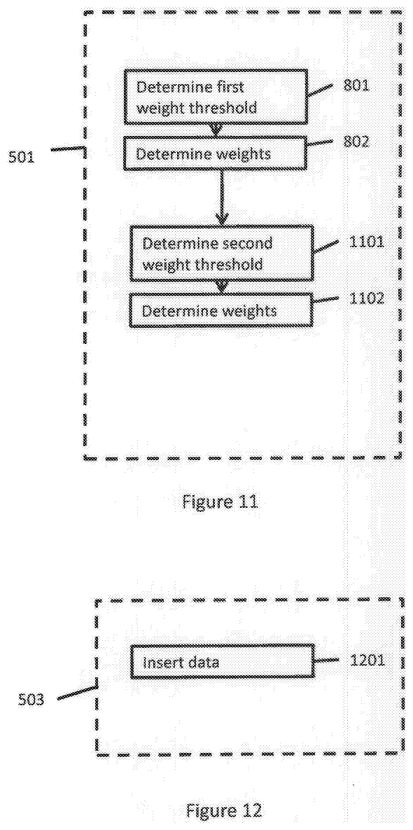

As described above, the neural network 900 could be trained for other types of data than durations (such as call durations), and the communication service does not need to relate to voice calls. While in theory it would be possible to train a neural network to deal with multiple types of data, this would increase the number of nodes in the network, whereby the computational complexity would increase. Instead, separate neural networks may be trained to predict billing disputes using different types of data. Such an example is described below with reference to FIG. 11.

FIG. 11 shows a scheme for how training 501 of a model in the method 500 may be performed with two neural networks, according to an embodiment. As described above with reference to FIG. 10, one neural network 900 may be trained for predicting disputes using one type of data (for example call durations). The training involves determining 801 a weight threshold, and then determining 802 weights for the neural network 900 subject to the constraint set by the weight threshold. Analogously, a second neural network may be trained for predicting disputes using another type of data (for example recipient locations, which may also be represented as real numbers for insertion into input nodes of a neural network). In the present embodiment, the training 501 involves determining 1101 a second weight threshold (for example using reinforcement learning), and then determining 1102 weights for the second neural network subject to the constraint set by the second weight threshold. An overall prediction model comprising these two neural networks may then be able to predict 503 billing disputes. If a billing dispute is predicted 503, the model may also provide an indication about which factor may be relevant for the predicted billing dispute (such as call durations or recipient locations). Such information may be useful for the system or person that is supposed to perform further analysis to figure out what is actually wrong, before a bill is sent to the customer.

It will be appreciated that separate neural networks may be trained for different customers.

### 4. Reinforcement Learning

As described above in relation to FIG. 8, the weight threshold employed in the neural network 900 may be determined 801 using reinforcement learning. An example type of reinforcement learning which may be employed for this purpose is Q-learning. How reinforcement learning may be employed is exemplified below.

According to some embodiments, the historical data employed at step 501 of the method 500 includes data about multiple collections of uses of the communication service by the customer and information regarding whether bills generated for the respective collections of uses of the communication service by the customer have been disputed. The weight threshold may be determined 801 using reinforcement learning based on the data about one or more of the multiple collections of uses of the communication service by the customer and the information regarding whether bills generated for the respective one or more collections of uses of the communication service by the customer have been disputed. In other words, the particular customer's call pattern is employed in the reinforcement learning to compute a suitable weight threshold for the neural network 900.

As described above in relation to FIG. 8, the data about uses of the communication service may for example be of one of the following types
durations of uses of the communication service; or
start times of uses of the communication service; or
end times of uses of the communication service; or
recipient locations of uses of the communication service.

If such a type of data is to be employed for determining 802 weights in the neural network 900, then that type of data should also be employed in the reinforcement learning. If, for example, the type of service is voice calls and the type of data is call durations, then call durations should be employed in the reinforcement learning for determining 801 the weight threshold, and call durations should also be entered in the neural network 900 to determine 802 values for the weights in the neural network 900.

It will be appreciated that in the example described above with reference to FIG. 11, the type of data to be employed for determining 802 the weights in the first neural network should be employed in the reinforcement learning for determining 801 the weight threshold for that neural network. And similarly, the type of data to be employed for determining 1102 the weights in the second neural network should be employed in the reinforcement learning for determining 1101 the weight threshold for that second neural network.

According to some embodiments, the one or more collections of uses of the communication service by the customer employed for the reinforcement learning are the one or more most recent collections of uses of the communication service by the customer for which there is data included in the historical data. In other words, the most recent uses of the communication service by the customer (for example the last month's uses, or the two laths month's uses) are employed in the reinforcement learning to obtain the weight threshold. If only the most recent uses of the communication service by the customer are supposed to be inserted 1001 into the first input node 901 of neural network 900, as described above in relation to FIG. 10, then only those recent uses should be employed in the reinforcement learning. The weight threshold obtained in this way indicates how much importance should be attributed to the recent use pattern of the customer, when predicting whether new uses of the communication service by the customer are likely to lead to billing disputes.

According to some embodiments, states in the reinforcement learning (which is employed to determine 801 the weight threshold) represent whether bills generated for the respective uses of the communication service by the customer have been disputed, and actions in the reinforcement learning represent uses of the communication service by the customer. In such embodiments, the weight threshold may be determined based on an optimal reward of the reinforcement learning. The optimal rewards calculated using the reinforcement learning (RL) model represents the recent behavior of the end user. In this case, it will be useful if we use the optimal reward or some function of this as weight threshold for the multi-layer perceptron. For example, it can be optimal reward or inverse of the optimal reward.

Reinforcement learning will be further described below in sections 7-9.

### 5. Discretization

A customer may use of a communication service while a condition or state relevant for billing changes. For example, a pricing model or a currency exchange rate may change while the customer uses the communication service. This may for example happen if the user makes a phone call late in the evening, and which continues on until after midnight. Another condition that may change is that the customer may move to a new network, or even to a new country while in a call with a cell phone. In other words, the space of possible uses of the communication service is a continuous space which may be relatively difficult to analyze for finding patterns indicative of billing disputes. This continuous space may be discretized to facilitate analysis. More specifically, data for uses of the communication service which was in progress when a change of state took place may split into a portion corresponding to the part of the use that took place before the change of state and a portion corresponding to the part of the use that took place after the change of state. The training performed at step 503 in the method 500 may for example be performed for such discretized data.

FIG. 13 shows such a scheme for splitting data, according to an embodiment. In this embodiment, the historical data includes data about a use of the communication service which was in progress when a change of state took place. In the present embodiment, the step 503 of training of the model comprises
splitting 1301 the data about the use of the communication service (which was in progress when the change of state took place) into first data for a portion of the use located before the change of state and second data for a portion of the use located after the change of state, and
training 1302 the model using the first and second data.

The change of state may for example include
a change of pricing, and/or
a change of a currency exchange rate, and/or
a phone involved in the use connecting to a new network, and/or
a phone involved in the use moving to a new country, and/or
start of a new day in a time zone of a network element involved in the use.

It will be appreciated that the data about a new collection of uses of the network, which is employed for the prediction 503 step on the method 500, may be discretized in a similar way.

### 6. Embodiments of Systems, Computer Programs, Etc.

The methods and schemes described above with reference to FIGS. 5-13 represent a first aspect of the present disclosure. FIG. 14 shows a system 1400, according to an embodiment. The system 1400 represents a second aspect of the present disclosure. The system 1400 may for example be a billing system.

The system 1400 may for example comprise processing circuitry 1401 (such as one or more processors), at least one memory 1402 (such as a non-transitory computer-readable medium), and at least one interface 1403. These components of the system 1400 may be communicatively connected to each other, for example via wired and/or wireless connections. The interface 1403 may for example be configured to communicate with components outside the system 1400. The interface 1403 may for example comprise a transmitter for transmitting wired and/or wireless signals. The interface 1403 may for example comprise a receiver for receiving wired and/or wireless signals. The interface 1403 may for example be configured to convey power from an external power source to the processing circuitry 1401 and/or the memory 1402.

The system 1400 (or the processing circuitry 1401 of the system 1400) may for example be configured to perform the method of any of the embodiments of the first aspect described above with reference to FIGS. 5-13. The system 1400 (or the processing circuitry 1401 of the system node 1400) may for example be configured to perform the method 500 described above with reference to FIG. 5.

According to an embodiment, the system 1400 may comprise processing circuitry 1401 and at least one memory 1402 (or a non-transitory computer-readable medium) containing instructions executable by the processing circuitry 1401 whereby the system 1400 is operable to perform the method of any of the embodiments of the first aspect described above.

It will be appreciated that the system 1400 need not necessarily comprise all those components described above with reference to FIG. 14. For a system 1400 according to an embodiment of the second aspect, it is sufficient that the system 1400 comprises means for performing the steps of the method of the corresponding embodiment of the first aspect.

According to an embodiment, a non-transitory computer-readable medium, such as for example the at least one memory 1402, may store instructions which, when executed by a computer (or by processing circuitry such as 1401), cause the computer (or the processing circuitry 1401 or the system 1400) to perform the method of any of the embodiments of the first aspect described above.

It will be appreciated that a non-transitory computer-readable medium 1402 storing such instructions need not necessarily be comprised in the system 1400. On the contrary, such a non-transitory computer-readable medium could be provided on its own, for example at a location remote from the system 1400.

It will be appreciated that processing circuitry 1401 (or one or more processors) may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide computer functionality, either alone or in conjunction with other computer components (such as a memory or storage medium).

It will also be appreciated that a memory or storage medium 1402 (or a non-transitory computer-readable medium) may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by a processor or processing circuitry.

### 7. Reasons for Using Reinforcement Learning

The text in this and the following sections of the detailed description is provided in the context of voice calls. However it will be appreciated that the analysis and explanations provided herein may be applied also to other communication services.

A billing dispute is, in part, a result in the inherent difficulty in maximizing the required reason as a value function in a continuous billing process, even in a low-dimensional voice process. Instead, recent reinforcement learning techniques can be employed to understand the required characteristics from discrete problems by introducing new models that allow maximization, as will be described further below.

We want to control the large discrete space of actions (multiple patterns in different transactions are identified during billing) after discretizing each of the dimensions of continuous control action spaces (billing calculation based plan and roaming time). For an example, if the M dispute patterns are discretized into N cases, the problem would increase the discrete space with M^{N} possible actions. In other words, there would be an exponential increase in the number of possible actions. We would like to leverage the recent success of sequence-to-sequence type models to train our discretized models without having to deal with such an exponentially large number of actions.

Hence we use value function of interest in Q-learning (a type of off-policy reinforcement learning, RL, algorithm) by decomposing the joint function of different period of voice transactions into a sequence of conditional values tied together. With the formation, we are able to understand the patterns in CDR's relevant for future billing disputes, without an explosion in the number of other reasons. That is, we are introducing an ability to our model to perform global maximization for tagging the specific patterns to each billing dispute by providing suitable rewards to user transactions. Hence there is no need to explore entire exponential space of CDR patterns. Here, we would like to use neural networks to perform approximate exponential search to understand the relevant patterns in CDRs during the specific time of billing calculation which may later lead into a billing dispute. During the time of choosing suitable function approximation in RL, we may for example use off-policy settings with sequential deep Q-network algorithm.

An advantage of the proposed solution is that it can be made self-learning because of the presence of RL and hence it can be self-sustained in longer time. The approach to move the data from continuous space to discrete space helps the machine learning models to execute and predict the dispute patterns.

Reinforcement learning and Q-learning will be described further below.
8. Example Implementation of the Proposed Method with Reinforcement Learning and Neural Network

As part of our new system to identify billing disputes, we are going to introduce an analytic solution component within the charging and billing module for understanding the reasons for the disputes and for applying further analysis by experts to solve problems before disputes arise. This proposed analytic component has two parts. First, it uses database history (in other words, historical data) of disputed invoices to train the neural network model. A second part is a procedure to identify the suspected invoices by projecting the details into discretized space to allot rewards with the implementation of Q-learning (which is an example of reinforcement learning). Hence, we have created an environment to both leverage the compositional structure of understanding the reasons from old dispute patterns during learning, as well as to figure out the future problem dispute Call Detail Records (CDR) during regular invoice calculation. For the second part of the solution, we have applied off-policy Q-learning for understanding the suspicious behavior of users through processing their CDR's.

We introduce the idea of building a continuous control algorithm (during billing) utilizing sequential, or autoregressive, models that predict over action spaces (dispute patterns) by one dimension (processing CDR's for particular user transactions) at a time. In other words, one type of data from the CDR is considered at a time (for example call durations). For this we use discrete distribution over each dimension (discretized each continuous dimensions) and apply it using off-policy learning.

A database may store the whole history of disputed invoices. The details are in depth based on types of data such as the DURATION, REGION, COUNTRY, SOURCE_DESTINATION (Unknown calls) for the respective calls. It can also contain RATE_PLAN and SERVICE based disputes.

The solution will have a procedure to identify the future dispute symptoms based on a machine learning algorithm. Several parameters may be used to identify the dispute patterns. Below are the few of them.

1. Rate plan

2. Call Duration

3. Source MSISDN's

4. Destination MSISDN's

5. Unknown calls

Here, database contains all the information regarding the history of the disputes and relevant patterns. The procedure to classify or predict whether an invoice is dispute or not is discussed below.

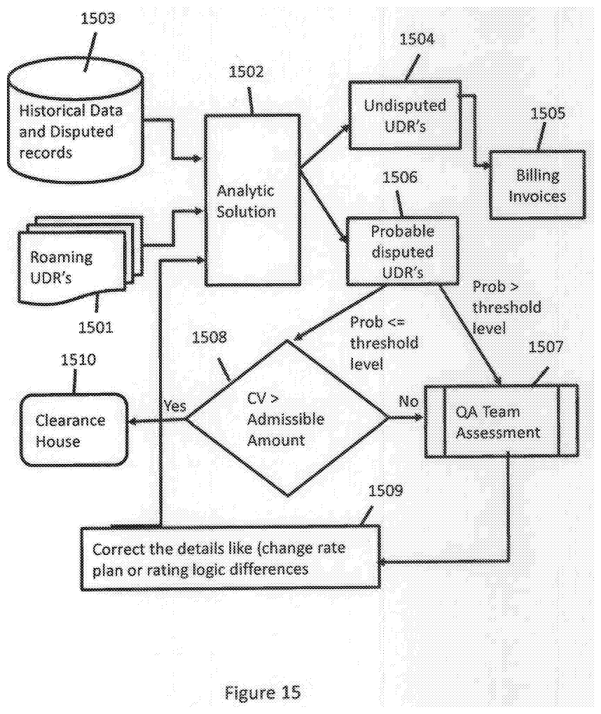

A proposed QA process in a billing cycle is illustrated in FIG. 15, and will be explained in detail below.
1. Roaming (usage detail records) UDRs 1501 are input to the Analytic Solution (AS) 1502.
2. The AS analyzes based on the historical data 1503 which was identified earlier based on the disputed patterns.
3. The AS segregates the probable disputed pattern UDR with reason for probable disputes and the cost involved and goes to step 4. It splits into two directions based on the calculated probability value. If probability value is greater than threshold, it redirects to step 4, otherwise step 6. Here non-disputed UDRs 1504 are sent for billing invoices 1505. Go to step 10.
4. Disputed patterned UDRs 1506 will be analyzed by Quality Assurance Team (QAT) 1507, and they cross check with original CDR's with reason for dispute.
5. QAT output gives the possible correction and checks the output value of disputed patterns UDR/CDR of entire duration of the party stayed.
6. The calculated output value will be checked with the configured threshold value 1508, if its greater go to step 9.
7. If the calculated output value is reasonable (compared to configured threshold value) then send it to node 1509 where the correction will made (EX: reason “RATE plan changed or Rating logic differences”).
8. The node 1509 assigned will do the correction and send it to AS 1502 (step 2) for another cycle of process.
9. Cross check with clearance house 1510 for further processing of CDR's. Go to 11.
10. Billing will proceed 1505.
11. Settlement process.

Here to process the UDR's in analytic solution, we construct a neural network (such as a multi-layer perceptron) to model this process. An advantage of using a multi-layer perceptron is that every node has unique weight and this is not a sequence actions.

If you design the new model in that way, every data may get an equal weightage. However, the history of the specific customer (in other words, the customer for which you are trying to predict a billing dispute) should get higher weightage than the remaining ones. But, there is a question is how much it should be higher. A lower threshold for some of the weights in the neural network is therefore computed by reinforcement learning technique as it should interact with the environment and learn it. Hence, we propose a reinforcement learning (RL) based method to determine a suitable weight threshold for some weights in the neural network along with normal gradient descent algorithm to calculate other weights. However, it should be remembered that the optimal weights obtained in this way will not be global optimal since a constraint (the weight threshold) has been introduced in the optimization. The proposed method has two parts, (8.1) RL to calculate the weight threshold and (8.2) multi-layer perceptron to understand the classification of dispute patterns based on its merits.

### 8.1 Reinforcement Learning, RL

Here, we use Q-learning as RL method to calculate the weight threshold. The Q-learning method is a model-less RL technique available and is easy to use. The basic concept of Q-learning is explained below.

For a Q-Learning Off-policy method, a value function is a prediction of future reward:
“How much reward will I get from action a in state s?”
   The Q-value function gives expected total reward:
From state s and action a
Under policy π
With discount factor γ

Q^{π}(s,a)=E[rₜ₊₁+γr₂₊₂+γ²r^{t+3}+ . . . |s,a]

The concerned Bellman equation is written as

Q^{π}(s,a)=E_{s′,a′}[r+γQ^{π}(s′,a′)|s,a]

The states here represent the status of the history of the bills i.e. whether they were disputed or not. The actions represent the call pattern of the customer roaming in another country. Since, we know the actions here, it is possible to obtain best possible state which gives you maximum reward. Then, based on the predicted state of the particular bill, it is easy to obtain the optimal reward. The optimal reward (or it's inverse) obtained can be taken as the lower threshold on the weight obtained in the neural network. This is used to train the neural network in the next step. The choice of the weight threshold depends on the application. For example, if there is no RL, then the weight threshold can be a predefined number such as 0.5. However, this can be misleading in some cases as the original user behavior is not captured by such a predefined weight threshold. Hence, we used RL to compute the optimal weight threshold. The output of the RL, i.e. the optimal reward, either can be directly used as the weight threshold or some transformation of the optimal reward can be used as the weight threshold. A reason for doing like this is that the reward information will have good pattern on the recent call history. In some example implementations, we use the inverse of the optimal reward as weight threshold in a multi-layer perceptron. We have tested different transformations of the optimal reward and found that the inverse transformation gave good results.

For example, call durations may be the type of data employed in the RL. In such an example setting, we insert the call durations of recent calls to the RL model. The amount of recentness can be for example one month or two months. First, we label the each of the recent calls as dispute or not dispute corresponding to the charges received in past. This can be done manually. The value of the reward depends on the value of dispute of the call. This is the data fed into the RL model. For RL model, we need to pass a matrix of rewards and actions. This is a two-dimensional matrix which will correspond to initial state s and next probable state s′. From this point, you can see we need to input a big three-dimensional matrix for RL. However, since we are dealing with non-sequential data it is enough we pass a two-dimensional matrix itself. Now, Q-learning will start on the first call, it will come with the optimal reward on the remaining calls. The optimal reward is calculated accounting the discounted factor for current reward and earlier rewards. Now, if we see correctly, the optimal reward will be higher if there are more dispute calls. In this way, it can be a good indicator of dispute calls. This forms the training of the RL model. For testing the RL model, we use the model to monitor the current month calls. Based on the learned trained patterns of earlier calls, the model will assign the rewards. Once, this is done we will calculate the optimal reward as summation of assigned rewards accounting to discounted factor. This is a good starting point. This is passed on to the neural network model.

### 8.2 Multi-Layer Perceptron

As discussed, we construct a multi-layer perceptron to train the network. In the network, as mentioned we use the modified gradient descent approach to obtain the solution. Normally, in the training of the neural network we use back propagation to get the result. Here also, we use the same approach to get the result. However, we include a constraint to make the weights of paths from a particular node greater than a particular weight threshold. An example neural network is shown in FIG. 9.

In this case, the number of input nodes 901-903 is three and the number of output nodes 907-908 is 2, which is equal to the number of classes (dispute, and not dispute). The first input node 901 is employed for the call history of the specific customer, the second input node 902 is employed for the past dispute history of the specific customer when visiting a particular country, and the third input node 903 is employed for the past dispute history of all customers when visiting the particular country. As discussed we give more weightage to the first input node 901. We compute the lower weight threshold by using RL in the previous step 8.1. To compute the weight in the neural network, we use the general gradient descent in addition with a constraint to compute the predictions. The modified optimization problem which is to be solved to learn the weights wᵢ is

$${min}_{{w}_{i}} {y}_{k} - {y}_{k} ( x ) , subject to the constraint {w}_{1} \geq C , {w}_{2} \geq C , {w}_{3} \geq C$$

where w₁, w₂, w₃ are the weights for the three paths from the first input node 901 to the nodes 904-906 in the hidden layer, and the weight threshold C comes from the reinforcement learning. We use the following information to train the network.
As discussed, we use three input nodes 901-903 in the input side. For the second input node 902 we use the call pattern of the customer X travelling to country Y, which ended in disputes. Here, we aggregate all such call data records of the customer X country wise and pass the thing to the network. The aggregation is done country wise because of the black box nature of the neural network. In general, any neural network based classification will give the idea of the category which the given input belongs to without specifying the reason behind it. In some embodiments of the proposed approach, the system can give the experts the probable disputed CDR's along with the reasons behind it. Hence, we chose to aggregate the CDR's at a granular level on the country wise. This can result in the better judgment by the expert's as they can easily relate the dispute to travelled country.

The variable fed to the network may for example be call duration, time of the call, or the recipient location of the call. Since we only have three input nodes, only one variable is employed for each call. A larger neural network could be designed to handle multiple variables, but that would significantly increase the computational complexity.

For the third input node 903 we use the call pattern of all the customers travelling to the country Y, which ended in disputes. Here, also we aggregated all the call data records of the customers as discussed above. For the first input node 901, we use the current (or recent) call pattern of the customer X. This may be important for performance since the call pattern of the customer may have been changed after travelling to the country X. Let's say he is making more calls than usual to a particular number etc. Hence, we may use recent call records for the first input node 901 to give more importance to recent call records while training the network. For this, we use the lower weight threshold C computed via reinforcement learning when training the network.

### 9. Mathematical Formulation of the RL in an Example Embodiment of the Proposed Method

Let sₜϵR^{L} be the transactions of the agent (RL agent), uϵR^{N} be the N dimensional action space (the CDR for the month is considered as one period of data of length N, where N may be different for different persons and for different months) and ξ be the stochastic environment (random CDR period) in which the user's (in other words, the customer's) billing calculation should happen. Finally let u^{i:j}=[uⁱ . . . uⱼ]^{T} be the vector obtained by taking the sub range of u=[u¹ . . . u^{N}]^{T}. That is selecting only relevant user transactions from the overall transactions of the user to detect the dispute behavior.

At each step t, the agent identifies some transactions sₜ, receives a reward rₜ from environment and transitions stochastically to a new state (new set of transaction based on the user roaming to new place) sₜ₊₁ according to dynamics p (sₜ₊₁|sₜ, sₜ₊₁). An episode (new set of transactions CDR's related to one single user on specific period) consists of a sequence of mobile phone transactions (CDR's) of steps (sₜ, aₜ, rₜ, sₜ₊₁), with t=1 . . . H different time periods where H is the last time stamp (came back to original place after roaming to new place) and γ is the discounted factor. An episode terminates when a stopping criterion F(sₜ₊₁) is true (for example from historical billing dispute patterns, we found some similar occurrences in new CDR's).

Let Rₜ=Σᵢ₌ₜ^{H}γⁱ⁻¹rₜ be the discounted reward received by the agent starting at step t (some pattern matching happen relates to dispute history transactions) of an episode. As with the proposed Q-learning RL part, the goal of our agent is to learn a policy π(sₜ) that maximizes the expected future reward E[R^{H}] it would receive from the environment by following this policy. We define the optimal action-value function Q*(s; a) as the maximum expected return achievable by following any strategy, after seeing some sequence s and then taking some action a,

Q*(s;a)=max_{π}E[Rₜ|sₜ=s;aₜ=a;π],

where π is a policy mapping sequences to actions (or distributions over actions) that is whenever it observes relevant dispute patterns.

The optimal action-value function obeys an important identity known as the Bellman equation. This is based on the following intuition: if the optimal value Q*(s′; a′) of the sequence s′ at the next time-step was known for all possible actions a′, then the optimal strategy is to select the action a′ maximizing the expected value of r+Q*(s′; a′),

Q*(s;a)=E_{s′}[r+y max Q*(s′;a′)|s;a]

From this expression we calculate the optimal policy. That involves trying to maximize reward, which is the change variable at the RL. The normalized reward outputted may be employed as lower weight threshold in the multilayer perceptron.

### 10. Mathematical Formulation of the Multi-Layer Perceptron in an Example Embodiment of the Proposed Method

A sample multi-layer perceptron is shown in FIG. 9.

At each node except the input nodes, a weighted sum of outputs from nodes in the preceding layer is formed. An activation function may be employed at the nodes. In the present example network, we use two output nodes 907 and 908 for classification of bills as (i) disputed bills and (ii) undisputed bills. For this we use a softmax function of the sigmoid function

$$s ( {y}_{k} ) = \frac{1}{1 + {e}^{- {y}_{k}}}$$

which is applied to the weighted sum yₖ formed at the respective output node. Usually, to train such a neural network, one could use back propagation. Back propagation computes the weights of the inputs such that predicted output matches with the actual output. In this case, the output nodes provides the outputs s(y₁) and s(y₂). The network is trained with a constraint that the weights for the paths from the first input node 901 are greater than a weight threshold C. The minimization problem in this case can be written as

$${min}_{{w}_{i}} {\sum }_{k = 1}^{2} {y}_{k} - {y}_{k} ( x )$$

where yₖ is the true value and s(yₖ) is the output/prediction provided from the network. The only modification we make here is that we apply a lower threshold w₁≥C, w₂≥C, w₃≥C for the weights of the three paths leading from the first input node 901. We can use the normal gradient descent algorithm to compute the weights of the network. The only difference of the proposed algorithm compared to the general algorithm is that it will search for constraint satisfaction at the end of every step.

### 11. Example Implementation

We have provided the brief overview of Q-learning and neural networks relevant for the proposed methods, and now we will discuss how both the techniques are applied in predicting the dispute behavior during the time of regular billing cycles. It enables to bring suitable measure to avoid the possible disputes happening in future.

To implement the proposed method to classify whether or not an invoice (or bill) is likely to lead to a dispute, we use the real time call records of all the customers.

To demonstrate the current idea, we consider two scenarios

### 11.1 Faulty Data (Time Series Type)

Hence to demonstrate this, we used simulated data, not data of actual call records. The data chosen is the random data some of which is labeled as faulty data (dispute in our case) and non-faulty data (not dispute). For this we created 10 rows of data for a particular customer X in which 4 rows correspond to customer X when visiting a particular country, and for which there were disputes. In addition, we have another 5 rows of data corresponding to other customers when visiting the particular country, for which there were disputes. In this case, the objective is to classify a new data whether or not this is likely to lead to a dispute.

As a first step, we use the RL approach to calculate the lower weight threshold. For this, we use the recent (simulated) data for the customer X to train the RL. Here, it should be noted that this data corresponds to call pattern of the customer X. Some of the data may be faulty (disputed) and the remaining data is not disputed. We create a reward matrix in such a way that whenever the data is faulty, we use high reward and whenever the data is not faulty we use lower reward. There is no clear cut distinction between the high reward and low reward. We chose reward value greater than 0.2 as the high reward, and reward value lower than 0.2 as low reward. Further, the learning rate (discount factor) for this model is chosen as 0.4 so that more focus is on the latest reward rather than past rewards. We use the optimal reward obtained at the end as weight threshold in the neural network. In this example, the weight threshold is obtained as 0.56. This signifies that the network should give more importance to the recent data.

We train the network with all the data as explained in the proposed method. Finally, at the end of this step, we have the proposed network trained with billing transactions. The network trained is multi-layer perceptron with single hidden layer and three input nodes, two output nodes and three hidden layer nodes, as shown in FIG. 9.

To test the trained network, we created both disputed data and undisputed data to check. The data is passed on to the node, where the person travelled to particular country Y. We tested the network with the disputed data and the undisputed data. We found that both are classified correctly. The prediction for the disputed data is that there is a probability of 84% that it will be disputed. The prediction for the undisputed data is that there is a probability of 72% that it will not be disputed. Hence, in this example, the network predicts the data correctly.

### 11.2 Real Time Data

To check the performance of the network further, we will test the network with real time data i.e. of call data records. It is demonstrated below.

The CDR data considered here have thirteen columns. Each row in the data represents a call record which has a unique MSDN number, location from which call is made, location of the destination call, amount charged etc. A single call can have multiple rows in the CDR file. First, we aggregate all the rows in the data corresponding to each call in the CDR file. Further, we collect the data records corresponding to a particular country, since the main aspect of the algorithm lies in that. Further, we also select particular customer and get the recent call records. In this example, we select the destination country as France.
1. In addition to using a neural network to detect billing dispute patterns, it is also possible to check for specific signs that are indicative of future billing disputes. For example, the following procedure could be performed: Check the previous bills (consecutive bills). If there is too much variation in the bill month wise (1st $50; 2nd $55; 3rd $45, current between $150 and $1000), then current the bill can be related to suspicious activity. Then check step 2 for more details about the charges (one time)/rates(calls)
2. Check one or more of the following in the Billing module:
   a) Correct Rate plan for Roaming.
   b) Rate plan with ‘External call’ one time charges.
   c) Ensure the roaming calls are properly rated according to External/Roaming calls.
   d) Charges for Activation/Deactivations of services while roaming—is it according to the agreement?
   e) Incoming/forwarding call charges—is it according to the agreement?
   f) Is there any currency conversion/rounding problems?
      Billing disputes are predicted using the procedure below.

### 11.2.1 Preparation of the Data

First, we extract all the disputes where the country is matching with the current invoice transaction. Further, we extract the disputes of the concerned person (who gets the invoice) matching the country he visited. For example, let us assume a person X travelled to Paris past several times (10 times) and let us assume 5 times he got dispute in billing. Next, we collect all the details of the disputes of persons travelling to the same country. This is an important information which will be used to classify the dispute. At last, we extract the call patterns of the person for whom the invoice is raised.

### 11.2.2 Q-Learning:

Further, we use the Q-learning model to train the model. For this we use the past data of the customer's invoices/bills. In these invoices some are disputed and some are not disputed. For the bills which have been disputed, we chose high rewards. Finally, we use the Q-learning optimization to compute the final optimal reward for all the invoices of the customer. Higher number of disputes translates to higher optimal reward and vice-versa. In this case, there are 20 records for the customer of which 10 are disputed. The optimal reward obtained is 0.67, which is then employed as weight threshold in the neural network.

### 11.2.3 Training of Neural Network Model:

With the weight threshold obtained, we build a multi-layer perceptron. The multi-layer perceptron consists of three input nodes, one hidden layer with three nodes and output layer with two nodes. The three input nodes take the input of the customers (i) call pattern of the disputed invoices of all the customers travelled to France (corresponds to the input node 903 in FIG. 9) (ii) call pattern of the disputed invoices of the customer under consideration travelled to France (corresponds to the input node 902 in FIG. 9) and (iii) recent call pattern of the customer under consideration (corresponds to the input node 901 in FIG. 9).

As discussed already, we train the network with these inputs and outputs are the disputed label for each customer (for each invoice in the input node (iii)), with a constraint on the weights on the paths from the input node (iii). The weight threshold employed as constraint comes from the Q-learning implementation. We use a sigmoid softmax function at the end of the network to convert the numbers to probability. The weights obtained for the input node (iii) are 0.73, 0.82, and 0.67. From these results, you can see that all the three weights are greater than the weight threshold.

### 11.2.4 Testing of Neural Network Model:

For testing of the network, we use the recent call records (invoice) of the customer. In this invoice, the customer made more calls than usual. The objective here is to classify whether the invoice will be disputed or not. For this, the network will take the same inputs at the input nodes (i) and (ii). The input at the input node (iii) will be that of the customer's call pattern of this month. Next, the network is simulated and output is obtained. In the present example, we assume that there is a single output node which indicates whether or not a billing dispute is likely. The output value greater than 0.5 suggests the invoice will be disputed and vice-versa. In this case, the network delivered a probability of 0.7, suggesting that the invoice will be disputed, so the invoice should be further investigated and/or regenerated.

### 11.2.5 Another Example

Let us consider one more example of the case where the calls are charged even when the customer is under roaming plan. Here, assume the customer always subscribes a roaming plan when he is going away to another country. In this case, also the first and second inputs will remain same and third input will vary. In this case, the probability obtained is 0.92, suggesting there is high risk that the invoice will be disputed.

Like this, we can consider many scenarios in which the proposed method is useful in predicting billing disputes.

### 12. Miscellaneous

The person skilled in the art realizes that the proposed approach presented in the present disclosure is by no means limited to the preferred embodiments described above. On the contrary, many modifications and variations are possible. For example, the methods and schemes described above with reference to FIGS. 5-13 may be combined to form further embodiments. Further, it will be appreciated that the system 1400 shown in FIG. 14 is merely intended as an example, and that other systems may also perform the methods and schemes described above with reference to FIGS. 5-13. It will also be appreciated that the method steps described with reference to FIGS. 5-13 need not necessarily be performed in the specific order shown in these figures, unless otherwise indicated.

Additionally, variations to the disclosed embodiments can be understood and effected by those skilled in the art. It will be appreciated that the word “comprising” does not exclude other elements or steps, and that the indefinite article “a” or “an” does not exclude a plurality. The word “or” is not to be interpreted as an exclusive or (sometimes referred to as “XOR”). On the contrary, expressions such as “A or B” covers all the cases “A and not B”, “B and not A” and “A and B”. The mere fact that certain measures are recited in mutually different dependent embodiments does not indicate that a combination of these measures cannot be used to advantage.

1. A method comprising:
training a model to predict, based on data about a collection of uses of a communication service, whether the collection of uses of the communication service is likely to lead to a billing dispute, wherein the training is performed using historical data, wherein the historical data includes data about multiple collections of uses of the communication service and information regarding whether bills generated for the respective collections of uses of the communications service have been disputed by customers;
obtaining data about a new collection of uses of the communication service by a customer; and
predicting, using the trained model, whether the new collection of uses of the communication service is likely to lead to a billing dispute.

2. The method of claim 1, wherein the communication service relates to:
calls; and/or
data sessions; and/or
messages.

3. The method of claim 1, further comprising:
determining, based on the prediction, whether the data about the new collection of uses of the communication service is to be investigated further before a bill is sent to the customer for the new collection of uses of the communication service.

4. The method of claim 1, wherein training the model comprises:
determining values for weights in a first neural network,
wherein, optionally, the first neural network comprises three input nodes, a hidden layer of nodes, and an output node,
wherein, optionally, the model is configured to make predictions based on output from the output node.

5. The method of claim 4, wherein the values for the weights are determined subject to a first condition that values for some weights are to exceed a first weight threshold.

6. The method of claim 5, wherein training the model further comprises:
determining the first weight threshold using reinforcement learning.

7. The method of claim 6, wherein the reinforcement learning is based on a first type of data about uses of the communication service, wherein determining values for weights in the first neural network includes insertion of the first type of data about uses of the communication service into input nodes of the first neural network, and wherein the first type of data is:
durations of uses of the communication service; or
start times of uses of the communication service; or
end times of uses of the communication service; or
recipient locations of uses of the communication service.

8. The method of claim 7, wherein training the model further comprises:
determining values for weights in a second neural network subject to a second condition that values for some weights in the second neural network are to exceed a second weight threshold,
wherein the second weight threshold is determined using reinforcement learning based on a second type of data about uses of the communication service, wherein determining values for weights in the second neural network includes insertion of the second type of data about uses of the communication service into input nodes of the second neural network, wherein the second type of data is a different type than the first type of data, and wherein the second type of data is:
durations of uses of the communication service; or
start times of uses of the communication service; or
end times of uses of the communication service; or
recipient locations of uses of the communication service.

9. The method of claim 6, wherein the historical data includes data about multiple collections of uses of the communication service by the customer and information regarding whether bills generated for the respective collections of uses of the communication service by the customer have been disputed, and wherein the first weight threshold is determined using reinforcement learning based on the data about one or more of the multiple collections of uses of the communication service by the customer and the information regarding whether bills generated for the respective one or more collections of uses of the communication service by the customer have been disputed.

10. The method of claim 9, wherein states in the reinforcement learning represent whether bills generated for the respective uses of the communication service by the customer have been disputed, wherein actions in the reinforcement learning represent uses of the communication service by the customer, and wherein the first weight threshold is determined based on an optimal reward of the reinforcement learning.

11. The method of claim 9, wherein the one or more collections of uses of the communication service by the customer employed for the reinforcement learning are the one or more most recent collections of uses of the communication service by the customer for which there is data included in the historical data.

12. The method of claim 5, wherein the first condition prescribes that values for weights associated with a first input node of the first neural network are to exceed the first weight threshold.

13. The method of claim 12, wherein the historical data includes data about multiple collections of uses of the communication service by the customer and information regarding whether bills generated for the respective collections of uses of the communication service by the customer have been disputed, and wherein training the model comprises:
inserting, at the first input node, data from the historical data regarding uses of the communication service by the customer,
wherein, optionally, the data inserted at the first input node is data about the one or more most recent collections of uses of the communication service by the customer for which there is data included in the historical data.

14. The method of claim 13, wherein predicting whether the new collection of uses of the communication service is likely to lead to a billing dispute comprises:
inserting, at the first input node, data from the obtained data about a new collection of uses of the communication service by the customer.

15. The method of claim 13, wherein the new collection of uses of the communication service include uses of the communication service by the customer when visiting a certain country, wherein the first neural network comprises a second input node and a third input node, and wherein training the model includes:
inserting, at the second input node, data from the historical data regarding uses of the communication service by the customer when visiting the certain country, wherein the data inserted at the second input node relates to uses of the communication service for which bills were disputed; and
inserting, at the third input node, data from the historical data regarding uses of the communication service by customers when visiting the certain country, wherein the data inserted at the third input node relates to uses of the communication service for which bills were disputed.

16. The method of claim 1, wherein the historical data includes data about a use of the communication service which was in progress when a change of state took place, wherein training of the model comprises:
splitting the data about the use of the communication service which was in progress when the change of state took place into first data for a portion of the use located before the change of state and second data for a portion of the use located after the change of state; and
training the model using the first and second data.

17. The method of claim 16, wherein the change of state includes:
a change of pricing; and/or
a change of a currency exchange rate; and/or
a phone involved in the use connecting to a new network; and/or
a phone involved in the use moving to a new country; and/or
start of a new day in a time zone of a network element involved in the use.

18. A system comprising processing circuitry, memory comprising instructions, and at least one interface associated with the processing circuitry, wherein instructions when executed by the processing circuitry are configured to:
train a model to predict, based on data about a collection of uses of a communication service, whether the collection of uses of the communication service is likely to lead to a billing dispute, wherein the training is performed using historical data, wherein the historical data includes data about multiple collections of uses of the communication service and information regarding whether bills generated for the respective collections of uses of the communications service have been disputed by customers;
obtain data about a new collection of uses of the communication service by a customer via the at least one interface; and
predict, using the trained model, whether the new collection of uses of the communication service is likely to lead to a billing dispute.

19. (canceled)

20. (canceled)

21. A non-transitory computer-readable storage medium comprising a computer program product including instructions to cause at least one processor to:
train a model to predict, based on data about a collection of uses of a communication service, whether the collection of uses of the communication service is likely to lead to a billing dispute, wherein the training is performed using historical data, wherein the historical data includes data about multiple collections of uses of the communication service and information regarding whether bills generated for the respective collections of uses of the communications service have been disputed by customers;
obtain data about a new collection of uses of the communication service by a customer; and
predict, using the trained model, whether the new collection of uses of the communication service is likely to lead to a billing dispute.
